(19) United States
(12) Patent Application Publication
(10) Pub. No.: US 2015/0079294 A1
(43) Pub. Date: Mar. 19, 2015

(54) COATING COMPOSITIONS AND METHODS FOR THEIR USE

(71) Applicant: Bayer MaterialScience LLC, Pittsburgh, PA (US)

(72) Inventors: Kurt E. Best, Sewickley, PA (US); Joseph R. Kleer, Cresecent, PA (US)

(73) Assignee: Bayer MaterialScience LLC, Pittsburgh, PA (US)

(21) Appl. No.: 14/025,876

(22) Filed: Sep. 13, 2013

(51) Int. Cl. C09D 175/02

(52) U.S. Cl. CPC C09D 175/02
USPC 427/385.5; 524/178

(57) ABSTRACT

Coating compositions are described. The coating compositions include: (a) a polyisocyanate; (b) a polymeric polyol; (c) a polyaspartic ester; and (d) a chelated tin (IV) compound. Also disclosed are methods of using such coating compositions and substrates at least partially coated with a cured coating deposited from such compositions.

### FIELD OF THE INVENTION

The present invention relates to coating compositions and methods for using such coating compositions, such as in low temperature bake applications.

### BACKGROUND

Two-component polyurea coating compositions containing a polyisocyanate component and a polyaspartic ester component are suitable for the formation of coatings that are hard, elastic, abrasion resistant, solvent resistant, and/or weather resistant. They also cure quickly, which can provide productivity enhancements. Despite their wide-spread use, however, known coating compositions contain disadvantages which limit their use in some applications.

For example, in some applications, it is desirable to have a coating composition that, in addition to having attributes as described above, also cures to an abrasion resistant coating using relatively low bake temperatures (no more than 160° F. (71.1° C.) and, in some cases, no more than 140° F. (60° C.) or no more than 130° F. (54.4° C.)) and short dwell times (no more than 40 minutes and, in some cases, no more than 20 minutes), while also exhibiting an extended pot life (at least 10 minutes, or, in some cases, at least 15 minutes or at least 20 minutes).

Thus, it would be desirable to provide polyurea coating compositions exhibiting a combination of the foregoing attributes.

### SUMMARY OF THE INVENTION

In some respects, the present invention is directed to coating compositions. These coating compositions comprise: (a) a polyisocyanate; (b) a polymeric polyol; (c) a polyaspartic ester corresponding to the formula:

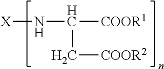

wherein: X is an aliphatic residue, R¹ and R² are organic groups that are inert to isocyanate groups at a temperature of 100° C. or less and may be the same or different organic groups; and n is an integer having a value of at least 2; and (d) a chelated tin (IV) compound, wherein (b) and (c) are present in the coating composition at a weight ratio of at least 1:1.

The present invention is also directed to coating compositions that comprise: (a) a polyisocyanate; (b) an acrylic polyol; (c) a polyaspartic ester having the structure:

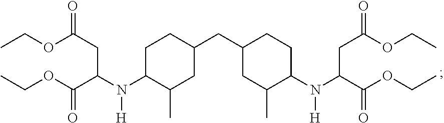 [SMILES: CCOC(=O)CC(NC1CCC(CC2CCC(NC(CC(=O)OCC)C(=O)OCC)C(C)C2)CC1C)C(=O)OCC]

and
(d) 0.5 to 1.5 percent by weight, based on the total weight of resin solids in the coating composition, of a chelated tin (IV) compound, wherein (b) and (c) are present in the coating composition at a weight ratio of 1:1 to 4:1.

The present invention also relates to, among other things, methods for using such coating compositions and substrates at least partially coated with a cured coating deposited from such compositions.

### DETAILED DESCRIPTION OF THE INVENTION

Various embodiments are described and illustrated in this specification to provide an overall understanding of the structure, function, operation, manufacture, and use of the disclosed products and processes.

It is understood that the various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112 and 35 U.S.C. §132(a).

The grammatical articles “a”, “an”, and “the”, as used herein, are intended to include “at least one” or “one or more”, unless otherwise indicated, even if “at least one” or “one or more” is used in certain instances. Thus, the articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, “polymer” encompasses prepolymers, oligomers and both homopolymers and copolymers; the prefix “poly” in this context referring to two or more. As used herein, the term “molecular weight”, when used in reference to a polymer, refers to the number average molecular weight, unless otherwise specified.

Certain embodiments of the present invention are directed to coating compositions, such as two-component coating compositions. As used herein, the term “two-component coating composition” refers to a composition comprising at least two components that are stored in separate containers because of their mutual reactivity. One component of such compositions is a hardener/crosslinker component comprising a polyisocyanate and another component of the composition is a binder component comprising an isocyanate-reactive resin, including the polymeric polyol and polyaspartic ester described herein. The two components are generally not mixed until shortly before application of the composition to a substrate. When the two separate components are mixed and applied as a film on a substrate, the mutually reactive compounds in the two components react to crosslink and form a cured coating film.

As used herein, the term “coating composition” refers to a mixture of chemical components that will cure and form a coating when applied to a substrate. As used herein, the term “binder” refers to the component of a two-component coating composition that comprises an isocyanate-reactive resin. As used herein, the terms “hardener” and “crosslinker” are synonymous and refer to the component of a two-component coating composition that comprises a polyisocyanate.

As indicated, the coating compositions of the present invention comprise a polyisocyanate. As used herein, the term “polyisocyanate” refers to compounds comprising at least two unreacted isocyanate groups, such as three or more unreacted isocyanate groups.

Suitable polyisocyanates include, for example, low molecular weight polyisocyanates having a molecular weight of 168 to 300, such as hexamethylene diisocyanate (HDI), 2,2,4- and/or 2,4,4-trimethyl-1,6-hexamethylene diisocyanate, dodecamethylene diisocyanate, 1,4-diisocyanatocyclohexane, 1-isocyanato-3,3,5-trimethyl-5-isocyanatomethylcyclohexane (IPDI), 2,4′- and/or 4,4′-diisocyanato-dicyclohexyl methane, 2,4- and/or 4,4′-diisocyanato-diphenyl methane and mixtures of these isomers with their higher homologues which are obtained in known manner by the phosgenation of aniline/formaldehyde condensates, 2,4- and/or 2,6-diisocyanatotoluene and any mixtures of these compounds.

In some cases, the polyisocyanate comprises a derivative of any of the foregoing monomeric polyisocyanates, such as a derivative containing biuret groups, isocyanurate groups, urethane groups, carbodiimide groups, and/or allophanate groups.

Specific examples of suitable modified polyisocyanates include N,N′,N″-tris-(6-isocyanatohexyl)-biuret and mixtures thereof with its higher homologues and N,N′,N″-tris-(6-isocyanatohexyl)-isocyanurate and mixtures thereof with its higher homologues containing more than one isocyanurate ring.

Isocyanate group-containing prepolymers and semi-prepolymers based on the monomeric simple or modified polyisocyanates exemplified above and organic polyhydroxyl compounds are also suitable for use as a polyisocyanate in the coating compositions of the present invention. These prepolymers and semi-prepolymers often have an isocyanate content of 0.5 to 30% by weight, such as 1 to 20% by weight or 10 to 20% by weight, and can be prepared, for example, by reaction of polyisocyanate(s) with polyhydroxyl compound(s) at an NCO/OH equivalent ratio of 1.05:1 to 10:1, such as 1.1:1 to 3:1, this reaction may be followed by distillative removal of any unreacted volatile starting polyisocyanates still present.

The prepolymers and semi-prepolymers may be prepared, for example, from low molecular weight polyhydroxyl compounds having a molecular weight of 62 to 299, specific examples of which include, but are not limited to, ethylene glycol, propylene glycol, trimethylol propane, 1,6-dihydroxy hexane; low molecular weight, hydroxyl-containing esters of these polyols with dicarboxylic acids; low molecular weight ethoxylation and/or propoxylation products of these polyols; and mixtures of the preceding polyvalent modified or unmodified alcohols.

In certain embodiments, the prepolymers and semi-prepolymers are prepared from a relatively high molecular weight polyhydroxyl compound having a molecular weight of 300 to 8000, such as 1000 to 5000, as determined from the functionality and the OH number. These polyhydroxyl compounds have at least two hydroxyl groups per molecule and generally have a hydroxyl group content of 0.5 to 17% by weight, such as 1 to 5% by weight.

Examples of suitable relatively high molecular weight polyhydroxyl compounds which may be used for the preparation of the prepolymers and semi-prepolymers include polyester polyols based on the previously described low molecular weight, monomeric alcohols and polybasic carboxylic acids such as adipic acid, sebacic acid, phthalic acid, isophthalic acid, tetrahydrophthalic acid, hexahydrophthalic acid, maleic acid, the anhydrides of these acids and mixtures of these acids and/or acid anhydrides. Hydroxyl group-containing polylactones, especially poly-ε-caprolactones, are also suitable for the preparation of the prepolymers and semi-prepolymers.

Polyether polyols, which can be obtained by the alkoxylation of suitable starting molecules, are also suitable for the preparation of the isocyanate group-containing prepolymers and semi-prepolymers. Examples of suitable starting molecules for the polyether polyols include the previously described monomeric polyols, water, organic polyamines having at least two NH bonds and any mixtures of these starting molecules. Ethylene oxide and/or propylene oxide are exemplary suitable alkylene oxides for the alkoxylation reaction. These alkylene oxides may be introduced into the alkoxylation reaction in any sequence or as a mixture.

Also suitable for the preparation of the prepolymers and semi-prepolymers are hydroxyl group-containing polycarbonates which may be prepared by the reaction of the previously described monomeric diols with phosgene and diaryl carbonates such as diphenyl carbonate.

In certain embodiments, the polyisocyanate comprises an asymmetric diisocyanate trimer (iminooxadiazine dione ring structure) such as, for example, the asymmetric diisocyanate trimers described in U.S. Pat. No. 5,717,091, which is incorporated by reference into this specification. In certain embodiments, the polyisocyanate comprises an asymmetric diisocyanate trimer based on HDI, IPDI; or a combination thereof.

The coating compositions of the present invention also comprise a polymeric polyol. As will be appreciated, in the coating compositions of the present invention, the polymeric polyol is distinct from, and in addition to, any polymeric polyol that may be used to prepare an isocyanate group-containing prepolymer or semi-prepolymer described above with respect to the polyisocyanate. In certain embodiments, the polymeric polyol comprises acid, such as carboxylic acid, functional groups.

Polymeric polyols suitable for use in the compositions of the present invention include polyester polyols, polyether polyols, and polycarbonate polyols, such as those described above with respect to the preparation of isocyanate group-containing prepolymers or semi-prepolymers.

In certain embodiments of the coating compositions of the present invention, however, the polymeric polyol comprises an acrylic polyol, including acrylic polyols that contain acid, such as carboxylic acid, functional groups. Acrylic polyols suitable for use in the coating compositions of the present invention include hydroxyl-containing copolymers of olefinically unsaturated compounds, such as those polymers that have a number average molecular weight (Mn) determined by vapor pressure or membrane osmometry of 800 to 50,000, such as 1000 to 20,000, or, in some cases, 5000 to 10,000, and/or having a hydroxyl group content of 0.1 to 12% by weight, such as 1 to 10% by weight and, in some cases, 2 to 6% by weight and/or having an acid value of at least 0.1 mg KOH/g, such as at least 0.5 mg KOH/g and/or up to 10 mg KOH/g or, in some cases, up to 5 mg KOH/g. Often, the copolymers are based on olefinic monomers containing hydroxyl groups and olefinic monomers which are free from hydroxyl groups. Examples of suitable olefinic monomers that are free of hydroxyl groups include vinyl and vinylidene monomers, such as styrene, α-methyl styrene, o- and p-chloro styrene, o-, m- and p-methyl styrene, p-tert-butyl styrene; acrylic acid; methacrylic acid; (meth)acrylonitrile; acrylic and methacrylic acid esters of alcohols containing 1 to 8 carbon atoms, such as ethyl acrylate, methyl acrylate, n- and iso-propyl acrylate, n-butyl acrylate, 2-ethylhexyl acrylate, 2-ethylhexyl methacrylate, iso-octyl acrylate, methyl methacrylate, ethyl methacrylate, butyl methacrylate and iso-octyl methacrylate; diesters of fumaric acid, itaconic acid or maleic acid having 4 to 8 carbon atoms in the alcohol component; (meth)acrylic acid amide; and vinyl esters of alkane monocarboxylic acids having 2 to 5 carbon atoms, such as vinyl acetate or vinyl propionate. Examples of suitable olefinic monomers containing hydroxyl groups are hydroxyalkyl esters of acrylic acid or methacrylic acid having 2 to 4 carbon atoms in the hydroxyalkyl group, such as 2-hydroxyethyl(meth)acrylate, 2-hydroxypropyl(meth)acrylate, 4-hydroxybutyl(meth)acrylate and trimethylolpropane-mono- or pentaerythritomono-(meth)acrylate. Mixtures of the monomers exemplified above may also be used for the preparation of the acrylic polyol. As will be appreciated, (meth)acrylate and (meth)acrylic is meant to encompass methacrylate and acrylate or methacrylic and acrylics, as the case may be.

Mixtures of the various polymeric polyols described above may be used.

The coating compositions of the present invention also comprise a polyaspartic ester corresponding to the formula (I):

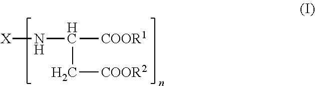

wherein: X is an aliphatic residue, R¹ and R² are organic groups that are inert to isocyanate groups at a temperature of 100° C. or less and may be the same or different organic groups, and n is an integer having a value of at least 2, such as 2 to 6 or 2 to 4.

In certain embodiments, X in formula (I) is a straight or branched alkyl and/or cycloalkyl residue of an n-valent polyamine that is reacted with a dialkylmaleate in a Michael addition reaction to produce a polyaspartic ester. For example, X may be an aliphatic residue from an n-valent polyamine including, but not limited to, ethylene diamine; 1,2-diaminopropane; 1,4-diaminobutane; 1,6-diaminohexane, 2,5-diamino-2,5-dimethylhexane; 2,2,4- and/or 2,4,4-trimethyl-1,6-diaminohexane; 1,11-diaminoundecane; 1,12-diaminododecane; 1-amino-3,3,5-trimethyl-5-aminomethylcyclohexane; 2,4′- and/or 4,4′-diaminodicyclohexylmethane; 3,3′-dimethyl-4,4′-diaminodicyclohexylmethane; 2,4,4′-triamino-5-methyldicyclohexylmethane; polyether polyamines with aliphatically bound primary amino groups and having a number average molecular weight (Mₙ) of 148 to 6000 g/mol; isomers of any thereof, and combinations of any thereof,

In certain embodiments, X may be obtained from 1,4-diaminobutane; 1,6-diaminohexane; 2,2,4- and/or 2,4,4-trimethyl-1,6-diaminohexane; 1-amino-3,3,5-trimethyl-5-aminomethylcyclohexane; 4,4′-diaminodicyclohexylmethane; 3,3′-dimethyl-4,4′-diaminodicyclohexylmethane; or 1,5-diamine-2-methyl-pentane.

As used herein, the phrase “inert to isocyanate groups,” which is used to define groups R¹ and R² in formula (I), means that these groups do not have Zerevitinov-active hydrogens. Zerevitinov-active hydrogen is defined in Rompp's Chemical Dictionary (Rommp Chemie Lexikon), 10th ed., Georg Thieme Verlag Stuttgart, 1996, which is incorporated herein by reference. Generally, groups with Zerevitinov-active hydrogen are understood in the art to mean hydroxyl (OH), amino (NHₓ), and thiol (SH) groups. In various embodiments, R₁ and R₂, independently of one another, are C₁ to C₁₀ alkyl residues, such as, for example, methyl, ethyl, or butyl residues.

In certain embodiments, n in formula (I) is an integer having a value of from 2 to 6, such as from 2 to 4, and in some embodiments, n is 2.

The polyaspartic ester present in the coating compositions of the present invention may be produced by reacting a primary polyamine of the formula:

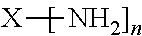

with maleic or fumaric acid esters of the formula:

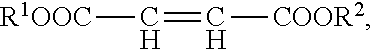

wherein X, n, R¹ and R² are as described earlier with respect to formula (I).

Examples of suitable polyamines include the above-mentioned diamines. Examples of suitable maleic or fumaric acid esters include dimethyl maleate, diethyl maleate, dibutyl maleate, and the corresponding fumarates.

The production of the polyaspartic ester from the above-mentioned polyamine and maleic/fumaric acid ester starting materials may take place within a temperature range of, for example, 0° C. to 100° C. The starting materials may be used in amounts such that there is at least one equivalent, and in some embodiments approximately one equivalent, of olefinic double bonds in the maleic/fumaric acid esters for each equivalent of primary amino groups in the polyamine. Any starting materials used in excess may be separated off by distillation following the reaction. The reaction may take place in the presence or absence of suitable solvents, such as methanol, ethanol, propanol, dioxane, or combinations of any thereof.

In certain embodiments, the polyaspartic ester comprises a reaction product of two equivalents of diethyl maleate with one equivalent of 3,3′-dimethyl-4,4′-diaminodicyclohexylmethane. Such a reaction product has the following molecular structure:

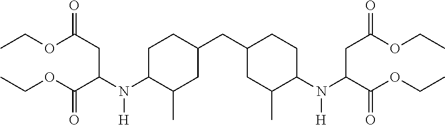 [SMILES: CCOC(=O)CC(NC1CCC(CC2CCC(NC(CC(=O)OCC)C(=O)OCC)C(C)C2)CC1C)C(=O)OCC]

In certain embodiments, the polyaspartic ester comprises a mixture of any two or more polyaspartic esters.

Examples of suitable polyaspartic esters that may be used in the coating compositions of the present invention are also described in U.S. Pat. Nos. 5,126,170; 5,236,741; 5,489,704; 5,243,012; 5,736,604; 6,458,293; 6,833,424; 7,169,876; and in U.S. Patent Publication No. 2006/0247371, In addition, suitable polyaspartic esters are commercially available from Bayer MaterialScience LLC, Pittsburgh, Pa., USA, and include, for example, Desmophen® NH 1520 and Desmophen® NH 1521.

In certain embodiments of the coating compositions of the present invention, components (a), (b) and (c) are used in amounts sufficient to provide an equivalent ratio of isocyanate groups to isocyanate-reactive groups of 0.8:1 to 20:1, such as 0.8:1 to 2:1, or, in some cases, 0.8:1 to 1.2:1 or 1:1.

Moreover, in certain embodiments of the present invention, (b) and (c) are present in the coating composition at a weight ratio of at least 1:1, such as from 1:1 to 4:1, or, in some cases, from 2:1 to 4:1. Indeed, it has been discovered, surprisingly, that synergistic interactions exist between these relative amounts of components (b) and (c), along with the use of the chelated tin(IV) compound described below, that enable the production of coating compositions exhibiting a good combination of extended pot life and reduced cure time at relatively low temperatures (no more than 160° F. (71.1° C.) and, in some cases, no more than 140° F. (60° C.) or no more than 130° F. (54.4° C.)) and short dwell times (no more than 40 minutes and, in some cases, no more than 20 minutes) to produce cured coatings that exhibits good abrasion resistance, among other properties.

As used herein, the term “pot life” refers to the period of time from the initial mixture of two or more mutually reactive components of a coating composition to the point at which the mixture exhibits a viscosity of 600 cps when measured according to ASTM Standard D 7395-07 using a Brookfield R/S Rheometer, also known as a Brookfield Cone and Plate, at 25° C. using a C50-1 spindle held at 50% torque+/−5%. In certain embodiments, the coating compositions of the present invention have a pot life of at least 10 minutes, such as at least 15 minutes or, in some cases, at least 20 minutes.

As used herein, the term “cure time” refers to the time to achieve Stage D (Method B) as defined in ASTM D5895-03 (2008)—Standard Test Methods for Evaluating Drying or Curing During Film Formation of Organic Coatings Using Mechanical Recorder, which is incorporated by reference into this specification. Likewise, the term “cured” refers to the condition of a liquid coating composition in which a film formed from the coating composition achieves Stage D as defined in ASTM D5895-03 (2008). As used herein, the terms “cure” and “curing” refer to the progression of a liquid coating composition from the liquid state to a cured state. A Stage D drying condition as defined in ASTM D 5895-03 is equivalent to a “dry-through” condition. In certain embodiments, the coating composition have a cure time of no more than 40 minutes, such as no more than 20 minutes, at a cure temperature of no more than 160° F. (71.1° C.), such as no more than 140° F. (60° C.) or no more than 130° F. (54.4° C.).

As indicated earlier, the coating compositions of the present invention comprise a chelated tin (IV) compound. Suitable tin compounds include tin(IV) compounds which are catalysts for the reaction between isocyanate groups and hydroxyl groups, i.e., compounds which increase the reaction rate between isocyanate groups and hydroxyl groups when compared to the reaction of these groups in the absence of a catalyst, such as by a factor of at least 10, a factor of at least 100 and, in some cases, a factor of at least 200, when present in an amount of 1 mole percent. Suitable tin(IV) compounds include organotin(IV) compounds containing ester, sulfide, bisulfide, thiol and/or halide groups, such as dialkyl tin(IV) compounds containing at least one of these groups. Examples of these compounds include dibutyltin diacetate, dibutyltin sulfide, dibutyltin dilaurate, dibutyltin mercaptide, dibutyltin diester, and dibutyltin bis-mercaptide.

In the coating compositions of the present invention, the tin (IV) compound is a chelated tin (IV) compound. As used herein, the term “chelated tin (IV) compound” refers to tin (IV) compounds in which tin ions are bound to, and have formed a complex with, a chelating agent, which is a compound with at least two electron-donor atoms capable of forming coordinate bonds with a metal atom.

In certain embodiments, the chelating agent used to form the chelated tin (IV) compound present in the coating compositions of the present invention comprises a (poly)carboxylic acid and/or a diketone. Exemplary diketones include, but are not limited to, 2,4-pentanedione type chelating agents, such as 2,4-pentanedione itself, 1,1,1-trifluoro-2,4-pentandione, and 1,1,1,5,5,5-hexafluoro-2,4-pentanedione.

In certain embodiments, the chelated tin(IV) compound is present in the coating composition an amount of 0.001 to 5 weight percent, such as 0.01 to 2 weight percent and, in some cases, 0.5 to 1.5 weight percent or 0.7 to 1.1 weight percent, based on the weight of resin solids in the coating composition. Indeed, it has been discovered that by using a chelated tin (IV) compound, the pot life of the coating composition can be extended to an extent sufficient to allow for the use of higher amount of tin (IV) compound than would otherwise be practicable, thereby providing a composition with adequate pot life and improved cure at relatively low bake temperatures and short dwell times.

The coating compositions of the present invention may comprise any of a variety of conventional auxiliary agents or additives, such as, but not limited to, defoamers, rheology modifiers (e.g., thickeners), leveling agents, flow promoters, colorants, fillers, UV stabilizers, dispersing agents, catalysts, anti-skinning agents, anti-sedimentation agents, emulsifiers, and/or organic solvents.

The coating compositions of the present invention may be formulated by preparing a crosslinker component comprising the polyisocyanate and by preparing a separate binder component comprising the polymeric polyol and polyaspartic ester. The chelated tin (IV) compound may be included in either or both components. The crosslinker component and the binder component of the two-component coating composition are typically mixed together at or near the time of use.

The present invention is also directed to methods of using the foregoing coating compositions. These methods comprise: (a) depositing the coating composition over at least a portion of a substrate; and (b) exposing the at least partially coated substrate to a temperature of 100° F. to 160° F. for not more than 40 minutes. As used herein, when it is stated that a composition is applied “over at least a portion of a substrate” it means that the composition can be applied either (i) directly on the substrate with no intervening coatings between the substrate and the composition or (ii) on a previously coated substrate so that one or more coatings, such as, for example, a conversion coating and/or a primer coating, is disposed between the substrate and the composition.

The coating compositions may be applied on to surfaces using various techniques, such as spraying, dipping, flow coating, rolling, brushing, pouring, and the like. The coating compositions can be applied onto any compatible substrate, such as, for example, metals, plastics, ceramics, glass, and natural materials, and to substrates that have been subjected to any pre-treatment that may be desirable.

After application, any solvents present in the applied coating evaporate, and the coatings cure and harden due to the crosslinking reactions between the polyisocyanate and the polymeric polyol and polyaspartic ester. In certain embodiments, the coating compositions of the present invention are cured by heating the coated substrate to a temperature of no more than 160° F. (71.1° C.), such as no more than 140° F. (60° C.) or no more than 130° F. (54.4° C.) for a time period of no more than 40 minutes, such as no more than 20 minutes. In certain embodiments, the cured coating has a dry film thickness of not more than 20 mils, such as not more than 10 mils, no more than 5 mils, or, in some cases, not more than 3 mils.

As will be appreciated from the foregoing, certain embodiments of the present invention are directed to a coating composition comprising: (a) a polyisocyanate; (b) a polymeric polyol; (c) a polyaspartic

ester corresponding to the formula:

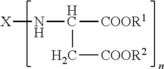

wherein: X is an aliphatic residue, R¹ and R² are organic groups that are inert to isocyanate groups at a temperature of 100° C. or less and may be the same or different organic groups; and n is an integer having a value of at least 2, such as 2 to 6, 2 to 4, or, in some cases, 2; and (d) a chelated tin (IV) compound, wherein (b) and (c) are present in the coating composition at a weight ratio of at least 1:1.

In embodiments, the present invention is directed to a coating composition of the previous paragraph, wherein the polymeric polyol comprises acid functional groups.

In embodiments, the present invention is directed to a coating composition of any of the previous two paragraphs, wherein the polymeric polyol comprises an acrylic polyol, such as an acrylic polyol having an Mn of 800 to 50,000, such as 1000 to 20,000 or 5000 to 10,000, and/or having a hydroxyl group content of 0.1 to 12% by weight, such as 1 to 10% by weight or 2 to 6% by weight, and/or having an acid value of at least 0.1 mg KOH/g, such as at least 0.5 mg KOH/g and/or up to 10 mg KOH/g or, in some cases, up to 5 mg KOH/g.

In embodiments, the present invention is directed to a coating composition of any of the previous three paragraphs, wherein the polyaspartic ester has the structure:

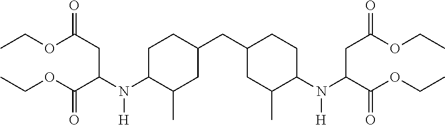 [SMILES: CCOC(=O)CC(NC1CCC(CC2CCC(NC(CC(=O)OCC)C(=O)OCC)C(C)C2)CC1C)C(=O)OCC]

In embodiments, the present invention is directed to a coating composition of any of the previous four paragraphs, wherein the polyaspartic ester comprises a reaction product of two equivalents of diethyl maleate with one equivalent of 3,3′-dimethyl-4,4′-diaminodicyclohexylmethane.

In embodiments, the present invention is directed to a coating composition of any of the previous five paragraphs, wherein (b) and (c) are present at a weight ratio of from 1:1 to 4:1.

In embodiments, the present invention is directed to a coating composition of any of the previous six paragraphs, wherein (b) and (c) are present at a weight ratio of from 2:1 to 4:1.

In embodiments, the present invention is directed to a coating composition of any of the previous seven paragraphs, wherein (d) is present in the composition in an amount of 0.1 to 5 percent by weight, based on the total weight of resin solids in the coating composition.

In embodiments, the present invention is directed to a coating composition of any of the previous eight paragraphs, wherein (d) is present in the composition in an amount of 0.5 to 1.5 percent by weight, based on the total weight of resin solids in the coating composition.

In embodiments, the present invention is directed to a coating composition of any of the previous nine paragraphs, wherein (d) is present in the composition in an amount of 0.7 to 1.1 percent by weight, based on the total weight of resin solids in the coating composition.

In embodiments, the present invention is directed to a coating composition of any of the previous ten paragraphs, wherein the tin (IV) compound is chelated with a chelating agent comprising a diketone.

In embodiments, the present invention is directed to a coating composition of any of the previous eleven paragraphs, wherein the diketone comprises 2,4-pentandione.

In embodiments, the present invention is directed to a coating composition of any of the previous twelve paragraphs, wherein the coating composition has a pot life of at least 15 minutes, such as at least 20 minutes.

In embodiments, the present invention is directed to a coating composition of any of the previous thirteen paragraphs, wherein the polyisocyanate comprises a prepolymer or semi-prepolymer having an isocyanate content of 0.5 to 30% by weight, such as 1 to 20% by weight, or 10 to 20% by weight.

In embodiments, the present invention is directed to a method of using a coating composition of any of the previous fourteen paragraphs, comprising: (a) depositing the coating composition over at least a portion of a substrate; and (b) exposing the at least partially coated substrate to a temperature of 100° F. to 160° F. for not more than 40 minutes, such as no more than 30 minutes.

In embodiments, the present invention is directed to a method of using a coating composition of the previous paragraph, wherein the exposure is at a temperature from 100° F. to 140° F. or 100° F. to 130° F. no more than 40 minutes, no more than 30 minutes or no more than 20 minutes.

In embodiments, the present invention is directed to a method of using a coating composition of any of the previous two paragraphs, wherein the method provides a cured coating having a film thickness of not more than 5 mils or no more than 3 mils.

As will also be appreciated from the foregoing description, certain embodiments of the present invention are directed to a coating composition comprising: (a) a polyisocyanate; (b) an acrylic polyol; (c) a polyaspartic ester having the structure:

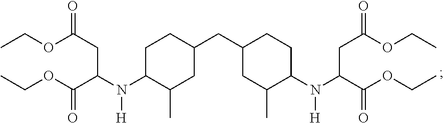 [SMILES: CCOC(=O)CC(NC1CCC(CC2CCC(NC(CC(=O)OCC)C(=O)OCC)C(C)C2)CC1C)C(=O)OCC]

and (d) 0.5 to 1.5 percent by weight, based on the total weight of resin solids in the coating composition, of a chelated tin (IV) compound, wherein (b) and (c) are present in the coating composition at a weight ratio of 1:1 to 4:1.

In embodiments, the present invention is directed to a coating composition of the previous paragraph, wherein the acrylic polyol has an Mn of 800 to 50,000, such as 1000 to 20,000 or 5000 to 10,000, and/or having a hydroxyl group content of 0.1 to 12% by weight, such as 1 to 10% by weight or 2 to 6% by weight, and/or having an acid value of at least 0.1 mg KOH/g, such as at least 0.5 mg KOH/g and/or up to 10 mg KOH/g or, in some cases, up to 5 mg KOH/g.

In embodiments, the present invention is directed to a coating composition of any of the previous two paragraphs, wherein (b) and (c) are present at a weight ratio of from 1:1 to 2:1.

In embodiments, the present invention is directed to a coating composition of any of the previous three paragraphs, wherein (d) is present in the composition in an amount of 0.7 to 1.1 percent by weight, based on the total weight of resin solids in the coating composition.

In embodiments, the present invention is directed to a coating composition of any of the previous four paragraphs, wherein the tin (IV) compound is chelated with a chelating agent comprising a diketone.

In embodiments, the present invention is directed to a coating composition of any of the previous five paragraphs, wherein the diketone comprises 2,4-pentandione.

In embodiments, the present invention is directed to a coating composition of any of the previous six paragraphs, wherein the coating composition has a pot life of at least 15 minutes, such as at least 20 minutes.

In embodiments, the present invention is directed to a coating composition of any of the previous seven paragraphs, wherein the polyisocyanate comprises a prepolymer or semi-prepolymer having an isocyanate content of 0.5 to 30% by weight, such as 1 to 20% by weight, or 10 to 20% by weight.

In embodiments, the present invention is directed to a method of using a coating composition of any of the previous eight paragraphs, comprising: (a) depositing the coating composition over at least a portion of a substrate; and (b) exposing the at least partially coated substrate to a temperature of 100° F. to 160° F. for not more than 40 minutes, such as no more than 30 minutes.

In embodiments, the present invention is directed to a method of using a coating composition of the previous paragraph, wherein the exposure is at a temperature from 100° F. to 140° F. or 100° F. to 130° F. not more than 40 minutes, no more than 30 minutes or no more than 20 minutes.

In embodiments, the present invention is directed to a method of using a coating composition of any of the previous two paragraphs, wherein the method provides a cured coating having a film thickness of not more than 5 mils or no more than 3 mils.

Illustrating the invention are the following examples that do not limit the invention to their details. All parts and percentages in the examples, as well as throughout the specification, are by weight unless otherwise indicated.

### EXAMPLES

### Examples A-O

Coating compositions were prepared using the ingredients and amounts (parts by weight) listed in Table 1. The coating compositions were made with a traditional high speed disperser. The disperser was charged with the Setalux® 17-1215 and Desmophen® NH 1520 followed by the BYK®-306. When required, the Dabco® T-12 composition was added and enough n-butyl acetate was added to make the volume solids 60% for all formulas. The compositions were allowed to set in the can for 24 hours before the Desmodur® N-3900 was added in an amount sufficient to provide an equivalent index of 1.1 NCO to 1.0 OH/NH and testing commenced.

TABLE 1

| | Example | | | | | | | |
|---|---|---|---|---|---|---|---|---|
| Ingredient | A | B | C | D | E | F | G | H |
| Setalux ® 17-1215¹ | 55.44 | 55.38 | 55.26 | 55.32 | 55 | 28.37 | 28.34 | 28.31 |
| Desmophen NH | — | — | — | — | — | 19 | 18.99 | 18.97 |
| 1520² | | | | | | | | |
| BYK ®-306³ | 0.11 | 0.11 | 0.11 | 0.11 | 0.11 | 0.1 | 0.1 | 0.1 |
| Dabco ® T-12⁴ | — | 0.66 | — | 1.32 | — | — | 0.65 | 1.31 |
| (10% by weight in | | | | | | | | |
| n-butyl acetate) | | | | | | | | |
| Dabco ® T-12 | — | — | 1.32 | — | 3.27 | — | — | — |
| (10% by weight in | | | | | | | | |
| 2,4 pentanedione) | | | | | | | | |
| Butyl Acetate, n- | 15.61 | 15.03 | 14.56 | 14.46 | 13 | 25.04 | 24.47 | 23.89 |
| Desmodur ® N- | 28.85 | 28.82 | 28.76 | 28.79 | 28.62 | 27.48 | 27.45 | 27.42 |
| 3900⁵ | | | | | | | | |
| Total | 100 | 100 | 100 | 100 | 100 | 100 | 100 | 100 |

Theoretical Results

| | | | | | | | | |
|---|---|---|---|---|---|---|---|---|
| Weight Solids | 66 | 66 | 65.92 | 66 | 65.81 | 65.51 | 65.51 | 65.5 |
| Wt/Gal | 8.68 | 8.66 | 8.67 | 8.66 | 8.68 | 8.53 | 8.53 | 8.53 |
| Volume Solids | 59.99 | 60 | 60 | 60 | 60 | 60 | 60 | 60 |
| Mix Ratio (volume) | 2.84:1 | 2.85:1 | 2.85:1 | 2.85:1 | 2.86:1 | 3.09:1 | 3.10:1 | 3.10:1 |
| NCO:OH | 1.1 | 1.1 | 1.1 | 1.1 | 1.1 | 1.1 | 1.1 | 1.1 |
| VOC | 2.94 | 2.94 | 2.95 | 2.94 | 2.97 | 2.94 | 2.94 | 2.94 |

| | Example | | | | | | |
|---|---|---|---|---|---|---|---|
| Ingredient | I | J | K | L | M | N | O |
| Setalux ® 17-1215¹ | 28.28 | 28.22 | 28.14 | 28.08 | 27.79 | 37.28 | 41.4 |
| Desmophen NH | 18.94 | 18.91 | 18.85 | 18.81 | 18.62 | 12.3 | 9.25 |
| 1520² | | | | | | | |
| BYK ®-306³ | 0.1 | 0.1 | 0.1 | 0.1 | 0.1 | 0.1 | 0.1 |
| Dabco ® T-12⁴ (10% | — | 3.26 | — | 6.48 | 12.83 | — | — |
| by weight in n-butyl | | | | | | | |
| acetate) | | | | | | | |
| Dabco ® T-12 (10% | 1.31 | — | 3.25 | — | — | 4.74 | 6.47 |
| by weight in 2,4 | | | | | | | |
| pentanedione) | | | | | | | |
| Butyl Acetate, n- | 23.98 | 22.17 | 22.39 | 19.33 | 13.72 | 17.95 | 15.05 |
| Desmodur ® N-3900⁵ | 27.39 | 27.34 | 27.26 | 27.2 | 26.93 | 27.63 | 27.73 |
| Total | 100 | 100 | 100 | 100 | 100 | 100 | 100 |

Theoretical Results

| | | | | | | | |
|---|---|---|---|---|---|---|---|
| Weight Solids | 65.42 | 65.5 | 65.31 | 65.48 | 65.47 | 65.39 | 65.38 |
| Wt/Gal | 8.54 | 8.53 | 8.56 | 8.53 | 8.53 | 8.61 | 8.64 |
| Volume Solids | 59.99 | 60 | 60 | 60 | 60.01 | 60 | 60.01 |
| Mix Ratio (volume) | 3.10:1 | 3.12:1 | 3.12:1 | 3.14:1 | 3.18:1 | 3.04:1 | 3.01:1 |
| NCO:OH | 1.1 | 1.1 | 1.1 | 1.1 | 1.1 | 1.1 | 1.1 |
| VOC | 2.95 | 2.94 | 2.97 | 2.94 | 2.94 | 2.98 | 2.99 |

¹67% by weight solids acrylic polyol (OH group content of 4.5% by weight and acid value of 5.0-10.0 mg KOH/gram on solids) solution from Nuplex Resins LLC
²Polyaspartic ester from Bayer MaterialScience LLC
³Silicone surface additive from BYK-Chemie GmbH
⁴Dibutyltin dilaurate from Air Products and Chemicals, Inc.
⁵Aliphatic polyisocyanate resin based on hexamethylene diisocyanate (HDI); NCO content ca. 24.0%; viscosity ca. 700 mPa- · s @ 23° C., from Bayer MateriaiScience LLC

### Pot Life Testing

Pot life of the coating compositions was measured as the time (in minutes) that it took for the coating composition to reach a viscosity of 600 cps, measured according to ASTM Standard D 7395-07 using a Brookfield R/S Rheometer, also known as a Brookfield Cone and Plate, at 25° C. using a C50-1 spindle held at 50% torque+/−5%. Results are shown in Table 2.

TABLE 2

| | | | dibutyltin | dibutyltin | |
|---|---|---|---|---|---|
| | | | dilaurate | dilaurate in | |
| Example | Acrylic¹ | PAE¹ | in nBA¹ | 2,4-pentanedione¹ | Pot life |
| A | 100 | 0 | 0 | 0 | 23 |
| B | 100 | 0 | 0.1 | 0 | 11 |
| C | 100 | 0 | 0 | 0.2 | 11 |
| D | 100 | 0 | 0.2 | 0 | 9 |
| E | 100 | 0 | 0 | 0.5 | 7 |
| F | 50 | 50 | 0 | 0 | 23 |
| G | 50 | 50 | 0.1 | 0 | 11 |
| H | 50 | 50 | 0.2 | 0 | 18 |
| I | 50 | 50 | 0 | 0.2 | 25 |
| J | 50 | 50 | 0.5 | 0 | 13 |
| K | 50 | 50 | 0 | 0.5 | 21 |
| L | 50 | 50 | 1 | 0 | 19 |
| M | 50 | 50 | 2 | 0 | 14 |
| N | 67 | 33 | 0 | 0.73 | 19 |
| O | 75 | 25 | 0 | 1 | 15 |

¹Values are % by weight based on total resin solids in the coating composition

### Cure Testing

Cure conditions were also evaluated as a primary goal was to reduce baking temperatures or time while still maintaining adequate speed of cure. The various coatings compositions where applied to zinc phosphate metal panels with a drawdown bar to a dry film thickness of 1 mil. Each coated panel was then placed in an oven for 20, 30 or 40 minutes at temperatures between 120° F. (48.9° C.) and 160° F. (71.1° C.) and then evaluated for cure by placing the panel under a scrape adhesion tester with a 10 lb weight. Each coated panel was tested when it was immediately removed from the oven and at 15, 30 and 45 minutes post bake. The degree of cure was determined by the marring of the coating using a round stylist in the scrape adhesion tester with the 10 lb weight. Results are set forth in Table 3. The rating scale was as follows: 0=not cured, coating was still flowing; 1=marred to substrate; 2=marred; 3=slight mar; 4=very slight mar; and 5=coating mar free. Therefore, higher values represent better results.

TABLE 3

| | Bake | Bake | | | | |
|---|---|---|---|---|---|---|
| Exam- | Temp. | Time | Initial | 15 minute | 30 minute | 45 minute |
| ple | (° F.) | (minutes) | Cure | post bake | post bake | post bake |
| A | 140 | 20 | 0 | 0 | 0 | 0 |
| A | 140 | 30 | 0 | 0 | 0 | 0 |
| A | 140 | 40 | 0 | 0 | 0 | 0 |
| B | 140 | 20 | 1 | 2 | 2 | 2 |
| B | 140 | 30 | 2 | 2 | 2 | 2 |
| B | 140 | 40 | 2 | 4 | 2 | 2 |
| C | 160 | 20 | 2 | 2 | 3 | 3 |
| C | 160 | 30 | 2 | 3 | 3 | 3 |
| C | 160 | 40 | 2 | 3 | 3 | 3 |
| D | 140 | 20 | 2 | 3 | 3 | 3 |
| D | 140 | 30 | 2 | 3 | 3 | 3 |
| D | 140 | 40 | 2 | 3 | 3 | 3 |
| E | 140 | 20 | 2 | 3 | 3 | 3 |
| E | 140 | 30 | 3 | 3 | 3 | 3 |
| E | 140 | 40 | 3 | 3 | 3 | 3 |
| F | 140 | 20 | 1 | 1 | 1 | 1 |
| F | 140 | 30 | 1 | 1 | 1 | 1 |
| F | 140 | 40 | 1 | 1 | 1 | 1 |
| G | 140 | 20 | 2 | 3 | 3 | 4 |
| G | 140 | 30 | 3 | 3 | 3 | 4 |
| G | 140 | 40 | 4 | 4 | 4 | 4 |
| H | 140 | 20 | 4 | 4 | 4 | 4 |
| H | 140 | 30 | 4 | 4 | 4 | 4 |
| H | 140 | 40 | 5 | 5 | 5 | 5 |
| I | 140 | 20 | 3 | 4 | 4 | 4 |
| I | 140 | 30 | 3 | 3 | 4 | 4 |
| I | 140 | 40 | 3 | 4 | 4 | 5 |
| J | 140 | 20 | 2 | 3 | 3 | 4 |
| J | 140 | 30 | 4 | 4 | 5 | 5 |
| J | 140 | 40 | 5 | 5 | 5 | 5 |
| K | 120 | 20 | 2 | 3 | 3 | 4 |
| K | 120 | 30 | 3 | 4 | 4 | 4 |
| K | 120 | 40 | 3 | 4 | 5 | 5 |
| L | 120 | 20 | 2 | 5 | 5 | 5 |
| L | 120 | 30 | 2 | 5 | 5 | 5 |
| L | 120 | 40 | 2 | 5 | 5 | 5 |
| L | 140 | 20 | 3 | 3 | 5 | 5 |
| L | 140 | 30 | 4 | 4 | 5 | 5 |
| L | 140 | 40 | 4 | 4 | 5 | 5 |
| M | 120 | 20 | 2 | 2 | 2 | 4 |
| M | 120 | 30 | 2 | 3 | 4 | 4 |
| M | 120 | 40 | 2 | 3 | 4 | 4 |
| N | 155 | 25 | 4 | 5 | 5 | 5 |
| O | 135 | 20 | 4 | 4 | 4 | 4 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A coating composition comprising:
(a) a polyisocyanate;
(b) a polymeric polyol;
(c) a polyaspartic ester corresponding to the formula: 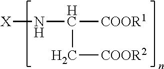
wherein: X is an aliphatic residue, R¹ and R² are organic groups that are inert to isocyanate groups at a temperature of 100° C. or less and may be the same or different organic groups; and n is an integer having a value of at least 2; and
(d) a chelated tin (IV) compound,
wherein (b) and (c) are present in the coating composition at a weight ratio of at least 1:1.

2. The coating composition of claim 1, wherein the polymeric polyol comprises acid functional groups.

3. The coating composition of claim 1, wherein the polymeric polyol comprises an acrylic polyol.

4. The coating composition of claim 1, wherein the polyaspartic ester has the structure:

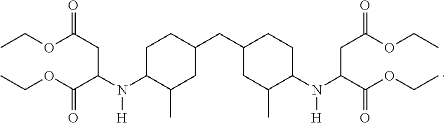 [SMILES: CCOC(=O)CC(NC1CCC(CC2CCC(NC(CC(=O)OCC)C(=O)OCC)C(C)C2)CC1C)C(=O)OCC]

5. The coating composition of claim 1, wherein (b) and (c) are present at a weight ratio of from 1:1 to 4:1.

6. The coating composition of claim 5, wherein (b) and (c) are present at a weight ratio of from 2:1 to 4:1.

7. The coating composition of claim 1, wherein (d) is present in the composition in an amount of 0.5 to 1.5 percent by weight, based on the total weight of resin solids in the coating composition.

8. The coating composition of claim 7, wherein (d) is present in the composition in an amount of 0.7 to 1.1 percent by weight, based on the total weight of resin solids in the coating composition.

9. The coating composition of claim 1, wherein the tin (IV) compound is chelated with a chelating agent comprising a diketone.

10. The coating composition of claim 9, wherein the diketone comprises 2,4-pentandione.

11. The coating composition of claim 1, wherein the coating composition has a pot life of at least 15 minutes.

12. A method of using the coating composition of claim 1, comprising:
(a) depositing the coating composition over at least a portion of a substrate; and
(b) exposing the at least partially coated substrate to a temperature of 100° F. to 160° F. for not more than 40 minutes.

13. The method of claim 12, wherein the exposure is at a temperature from 100° F. to 140° F. for not more than 30 minutes.

14. The method of claim 13, wherein the method provides a cured coating having a film thickness of not more than 5 mils.

15. A coating composition comprising:
(a) a polyisocyanate;
(b) an acrylic polyol;
(c) a polyaspartic ester having the structure: 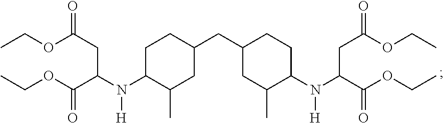 [SMILES: CCOC(=O)CC(NC1CCC(CC2CCC(NC(CC(=O)OCC)C(=O)OCC)C(C)C2)CC1C)C(=O)OCC]
and
(d) 0.5 to 1.5 percent by weight, based on the total weight of resin solids in the coating composition, of a chelated tin (IV) compound,
wherein (b) and (c) are present in the coating composition at a weight ratio of 1:1 to 4:1.

16. The coating composition of claim 15, wherein the acrylic polyol comprises acid functional groups.

17. The coating composition of claim 15, wherein the tin (IV) compound is chelated with a chelated agent comprising a diketone.

18. The coating composition of claim 15, wherein (b) and (c) are present at a weight ratio of from 2:1 to 4:1.

19. The coating composition of claim 15, wherein the coating composition has a pot life of at least 15 minutes.

20. A method of using the coating composition of claim 15, comprising:
(a) depositing the coating composition over at least a portion of a substrate; and
(b) exposing the at least partially coated substrate to a temperature of 100° F. to 160° F. for not more than 40 minutes.
